(19) United States
(12) Patent Application Publication
(10) Pub. No.: US 2021/0229810 A1
(43) Pub. Date: Jul. 29, 2021

(54) INFORMATION PROCESSING DEVICE, FLIGHT CONTROL METHOD, AND FLIGHT CONTROL SYSTEM

(71) Applicant: SZ DJI TECHNOLOGY CO., LTD., Shenzhen (CN)

(72) Inventors: Lei GU, Shenzhen (CN); Zongyao QU, Shenzhen (CN)

(21) Appl. No.: 17/233,431

(22) Filed: Apr. 16, 2021

Related U.S. Application Data
(63) Continuation of application No. PCT/CN2019/113654, filed on Oct. 28, 2019.

(30) Foreign Application Priority Data
Oct. 30, 2018 (JP) 2018-203824

(51) Int. Cl. B64C 39/02; G05D 1/08; G05D 1/10; B64F 1/00

(52) U.S. Cl. CPC B64C 39/024; B64F 1/007; G05D 1/101; G05D 1/0808

(57) ABSTRACT

An information processing device includes a processor and a storage device. The storage device stores a program that, when executed by the processor, causes the processor to obtain flight body relative position information and base absolute position information, receive set path information set in the flight body, obtain target path information for a current time point from the set path information, calculate, based on the target path information, a target position of the flight body for causing the flight body to fly along a set path, calculate a current absolute position of the flight body according to the flight body relative position information and the base absolute position information, calculate flight body control information according to the current absolute position of the flight body and the target position, and control the flight body to fly according to the flight body control information. The flight body relative position information indicates a relative position of a flight body relative to a base. The relative position is obtained by performing real time measurement on a measurement target object at the base. The base absolute position information indicates an absolute position of the base.

### CROSS-REFERENCE TO RELATED APPLICATIONS

This application is a continuation of International Application No. PCT/CN2019/113654, filed Oct. 28, 2019, which claims priority to Japanese Application No. 2018-203824, filed Oct. 30, 2018, the entire contents of both of which are incorporated herein by reference.

### TECHNICAL FIELD

The present disclosure relates to an information processing device, a flight control method, and a flight control system.

### BACKGROUND

Japanese Patent Publication No. 2010-61216 discloses a platform (e.g., unmanned aerial vehicle), which carries a camera device and performs photographing while flying along a preset flight path. The platform receives commands such as the preset flight path and a photographing instruction from a base. According to the commands, the platform flies, performs the photographing, and transmits obtained images to the base. When photographing an object, the platform flies along the determined fixed path and tilts the camera device of the platform according to a position relationship between the platform and the object to perform the photographing.

### SUMMARY

Embodiments of the present disclosure provide an information processing device including a processor and a storage device. The storage device stores a program that, when executed by the processor, causes the processor to obtain flight body relative position information and base absolute position information, receive set path information set in the flight body, obtain target path information for a current time point from the set path information, calculate, based on the target path information, a target position of the flight body for causing the flight body to fly along a set path, calculate a current absolute position of the flight body according to the flight body relative position information and the base absolute position information, calculate flight body control information according to the current absolute position of the flight body and the target position, and control the flight body to fly according to the flight body control information. The flight body relative position information indicates a relative position of a flight body relative to a base. The relative position is obtained by performing real time measurement on a measurement target object at the base. The base absolute position information indicates an absolute position of the base.

Embodiments of the present disclosure provide a flight control method. The method includes obtaining flight body relative position information and base absolute position information, receiving set path information set in the flight body, obtaining target path information for a current time point from the set path information, calculating, based on the target path information, a target position of the flight body for causing the flight body to fly along a set path, calculating a current absolute position of the flight body according to the flight body relative position information and the base absolute position information, calculating flight body control information according to the current absolute position of the flight body and the target position, and controlling the flight body to fly according to the flight body control information. The flight body relative position information indicates a relative position of a flight body relative to a base. The relative position is obtained by performing real time measurement on a measurement target object at the base. The base absolute position information indicates an absolute position of the base.

Embodiments of the present disclosure provide a flight control system. The system includes a flight body, a base, and an information processing device. The base is within a visible range of the flight body and includes a measurement target object. The information processing device includes a processor and a storage device. The storage device stores a program that, when executed by the processor, causes the processor to obtain flight body relative position information and base absolute position information, receive set path information set in the flight body, obtain target path information for a current time point from the set path information, calculate, based on the target path information, a target position of the flight body for causing the flight body to fly along a set path, calculate a current absolute position of the flight body according to the flight body relative position information and the base absolute position information, calculate flight body control information according to the current absolute position of the flight body and the target position, and control the flight body to fly according to the flight body control information. The flight body relative position information indicates a relative position of a flight body relative to a base. The relative position is obtained by performing real time measurement on a measurement target object at the base. The base absolute position information indicates an absolute position of the base.

### BRIEF DESCRIPTION OF THE DRAWINGS

FIG. 1 is a schematic block diagram of a flight control system according to some embodiments of the present disclosure.

FIG. 2 is a schematic diagram of the flight control system according to some embodiments of the present disclosure.

FIG. 3 is a schematic block diagram showing a functional configuration of a path calculator according to some embodiments of the present disclosure.

FIG. 4 is a schematic diagram showing an outer structure of a flight body according to some embodiments of the present disclosure.

FIG. 5 is a schematic block diagram showing a hardware configuration of the flight body according to some embodiments of the present disclosure.

FIG. 6 is a schematic flowchart of a flight control operation according to some embodiments of the present disclosure.

FIG. 7 is a schematic block diagram of another flight control system according to some embodiments of the present disclosure.

FIG. 8 is a schematic diagram of the another flight control system according to some embodiments of the present disclosure.

FIG. 9 is a schematic block diagram showing a functional configuration of another path calculator unit according to some embodiments of the present disclosure.

FIG. 10 is a schematic block diagram of another flight control system according to some embodiments of the present disclosure.

FIG. 11 is a schematic block diagram of a functional configuration of another path calculator unit according to some embodiments of the present disclosure.

### REFERENCE NUMERAL

10, 10A, 10B Flight control system
100, 100A, 100B Flight body
110 Flight body controller
120 Gimbal
130 Gimbal controller
140, 140A, 140B Relative position measurement unit
141 Measurement unit
142 Object detection unit
143 Relative position calculator
144 Relative speed calculator
150 Speed measurement sensor
160, 180 Sensor fusion unit
170 Speed and acceleration measurement sensor
300, 300A, 300B Flight control processor
310 Target path acquisition unit
320, 320A, 320B Path calculator
321 Flight body absolute position calculator
322 Target path information calculator
323 Flight body absolute speed calculator
324 Flight body absolute acceleration calculator
325 PID calculator
330 Transmitter
500, 600, 600A Base
510, 610 Measurement target object
520, 620 Position acquisition unit
550, 650 Sign
630 Speed measurement sensor
640 Speed and acceleration measurement sensor
1100 UAV body
1110 UAV controller
1150 Communication interface
1160 Memory
1170 Storage device
1200 Gimbal
1220 Imaging unit
1210 Rotor mechanism
1240 Global positioning system (GPS) receiver
1250 Inertia measurement unit (IMU)
1260 Magnetic compass
1270 Barometric altimeter
1280 Ultrasound sensor
1290 Laser measurement device

### DETAILED DESCRIPTION OF THE EMBODIMENTS

The present disclosure is described through embodiments, but following embodiments do not limit the invention related to the claims. Not all the feature combinations described in embodiments of the present disclosure are necessary for the solutions of the present disclosure.

An information processing device of the present disclosure may be included in a flight body, which is an example of a mobile body, and in at least one computer of a platform, which is configured to perform remote control on operations or processes of the flight body. The information processing device may be configured to execute various processes related to the operations of the flight body.

The flight control method of the present disclosure may set forth the various processes (i.e., steps) of the information processing device (e.g., the flight body or the platform). A program disclosed in the present disclosure may be configured to cause the information processing device (e.g., the flight body or the platform) to execute the various processes. A recording medium disclosed in the present disclosure may record the program, which is configured to cause the information processing device (e.g., the flight body or the platform) to execute the various processes.

The flight control system disclosed by the present disclosure may include a flight body, an information processing device (e.g., a flight body or a platform), and a base used for measuring the position of the flight body.

The flight body may include an aircraft (e.g., an unmanned vehicle, or a helicopter) movable in the air. The flight body may be an unmanned aerial vehicle (UAV) including a photographing device. To photograph a to-be-photographed object (e.g., a ground shape such as a building, a road, or a part within a certain range) within a photographing range, the flight body may fly along a preset flight path and photograph the to-be-photographed object at a plurality of photographing positions, which are set in the flight path. The to-be-photographed object may include a building, a road, or a bridge.

The platform may include a computer. The platform may include a processor, which may be configured to instruct control of various processes including the movement of the flight body. The platform may include a terminal, which may be configured to perform input and output of information or data and connected to a controller of the flight body. The terminal may include a personal computer (PC). In addition, when the flight body includes the information processing device, the flight body may be used as the platform.

In embodiments of the present disclosure, UAV is taken as an example of the flight body. In the accompanying drawings of the present disclosure, the unmanned aerial vehicle may be referred to as UAV. In some embodiments, the information processing device may be configured to control a flight operation when the flight body flies according to a preset target path. The information processing device, for example, may be arranged inside the flight body. The information processing device may also be arranged at another device (e.g., a PC or a server that communicates with the flight body). The information processing device may be arranged at a base including a measurement target object, as described below.

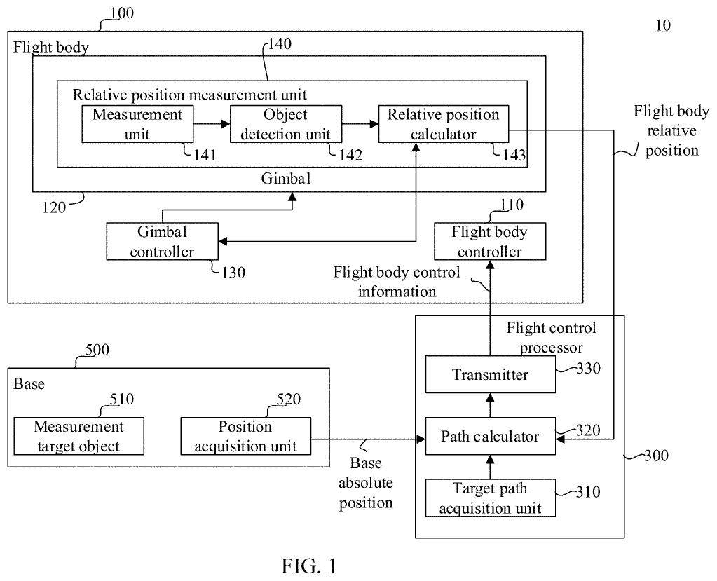

FIG. 1 is a schematic block diagram of a flight control system 10 according to some embodiments of the present disclosure. The flight control system 10 includes a flight body 100, a flight control processor 300, and a base 500. The flight body 100 and the flight control processor 300, and the base 500 and the flight control processor 300 may communicate with each other through wired communication or wireless communication (e.g., wireless local area network (LAN)).

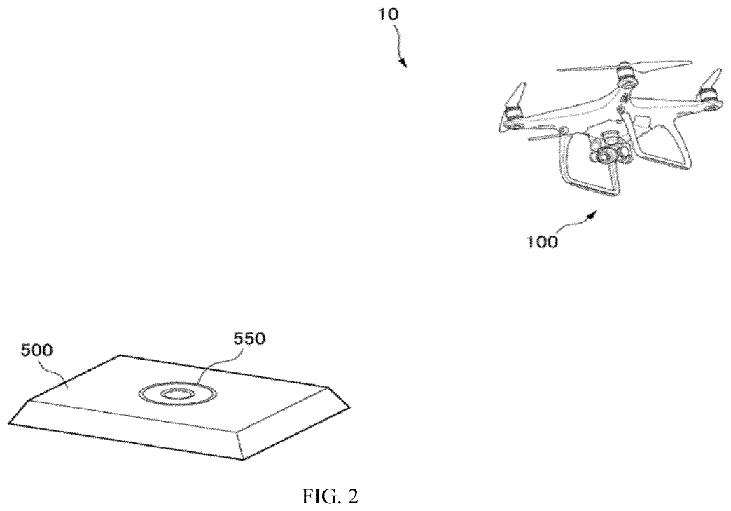

FIG. 2 is a schematic diagram of the flight control system 10 according to some embodiments of the present disclosure. In the example shown in FIG. 2, the base 500 is a base arranged on the ground. The base 500 may be configured as a measurement target object for the flight body 100 to measure a relative position through photographing. The base 500 includes a sign 550, which is an example of a visible target. The sign 550 is formed and arranged at an outer surface of the base 500, e.g., an upper surface. The flight body 100 may photograph the sign 550 of the base 500 by a camera of a photographing unit of a measurement unit to measure a relative position between the flight body 100 and the base 500. The base 500 is not limited to the base fixedly arranged on the ground but may also include a base arranged at a structure such as a building or a tower, a base arranged in water or air, or a mobile base moving on the ground, in the water, or in the air.

As shown in FIG. 1, the flight body 100 includes the flight body controller 110, a gimbal 120, and a gimbal controller 130. The gimbal 120 includes a relative position measurement unit 140. The gimbal 120, for example, may rotate freely about three axis directions. To cause the relative position measurement unit 140 to face the measurement target object, a direction of the relative position measurement unit 140 may be changed to a desired direction. The relative position measurement unit 140 includes a measurement unit 141, an object detection unit 142, and a relative position calculator 143. The relative position measurement unit 140 may be configured to measure and determine the relative position between the flight body 100 and the base 500. The measurement unit 141 may include an imaging unit including a time of flight (TOF) camera and an RGB camera, or a laser scanner. The gimbal controller 130 may output a drive signal to the gimbal 120 and physically control the direction of the gimbal 120 to cause the measurement unit 141 of the gimbal 120 to face the measurement target object of the base 500. The gimbal controller 130 may use a measurement result of the relative position obtained by the relative position calculator 143 as input to adjust the direction of the gimbal 120 through a feedback control. The flight body controller 110 may be configured to control the flight operation when the flight body 100 flies automatically according to the preset target path. The target path may include information such as a flight position (waypoint), which is configured to generate the flight path, control points as the base of generating the flight path, and flight time. The target path may include a flight position, which includes a photographing position for the to-be-photographed object. In the flight body 100, one or more of the flight body controller 110, the gimbal controller 130, the object detection unit 142, and the relative position calculator 143 may be a computer including a processor and a memory.

The base 500 includes a measurement target object 510 such as the sign 550 and a position acquisition unit 520, which may be configured to obtain the position of the base 500. When the measurement unit 141 of the flight body 100 includes the imaging unit that includes the TOF camera and the RGB camera, the sign 550 may be used as the measurement target object 510. The TOF camera may photograph the measurement target object 510. A distance between each pixel of an image of the measurement target object captured by the TOF camera and the to-be-photographed object (target object) of full pixels may be measured. The TOF camera may include a pulse light source and an imaging device. The TOF camera may measure 3-dimensional (3D) position information (distance information) by measuring a reflection time of pulse light of each pixel irradiated on the to-be-photographed object. The RGB camera may be a camera for capturing an RGB image. The RGB camera may be configured to calculate a pixel position of the to-be-photographed object according to color information (RGB information) of the image and measure an angle of the to-be-photographed object. The measurement unit 141 may photograph the sign of the measurement target object 510 by the TOF camera and the RGB camera and measure the distance and the angle to the measurement target object 510.

In addition, when the measurement unit 141 of the flight body 100 includes a laser scanner, the measurement target object 510 may apply a retro-reflector including prisms. The laser scanner may be configured to irradiate the measurement target object 510 with laser and measure the distance and angle to the measurement target object 510 according to reflected light reflected from the measurement target object 510. The laser scanner may be a measurement tool, which may be configured to measure the 3D position information of an object using a phase difference or reflection time and an irradiation angle of a laser beam through a measurement method of the phase difference or TOF. The measurement unit 141 may irradiate the laser to the retro-reflector of the measurement target object 510 by the laser scanner to measure the distance and the angle to the measurement target object 510. In addition, as the measurement unit 141 of the flight body 100, the imaging unit including the TOF camera and the RGB camera is described as an example below.

In the relative position measurement unit 140 of the flight body 100, the measurement unit 141 may detect and measure the measurement target object 510 of the base 500 by photographing and obtain measurement data of the image in real time. An object detection unit 142 may be configured to detect and follow the measurement target object 510 through object detection and following technology according to the measurement data of the image of the measurement unit 141 and output the information of the distance and the angle of the measurement target object 510. A relative position calculator 143 may be configured to derive and calculate a relative 3D position from the measurement target object 510 to the flight body 100 according to the information of the distance and the angle of the measurement target object 510 to obtain and output current relative position information of the flight body 100.

A position acquisition unit 520 of the base 500, for example, may include a global positioning system (GPS) measurement unit of a GPS sensor. When the position acquisition unit 520 includes the GPS measurement unit, the GPS measurement unit may obtain and output absolute position information of the base 500 based on the GPS 3D position of the base 500. The position acquisition unit 520 may keep or obtain the 3D position pre-measured by the GPS or through another measurement method to obtain the absolute position information of the base 500. The position acquisition unit 520 may include a memory or a storage device. In some embodiments, the position acquisition unit 520 may include a computer having a processor and a memory.

The flight control processor 300 is an example of the information processing device disclosed by the present disclosure. The flight control processor 300 includes a target path acquisition unit 310, a path calculator 320, and a transmitter 330. The target path acquisition unit 310 may use set path information such as a flight path preset by a person (referred to as a user) who uses the flight control system, a flight path calculated according to parameters designated by the user, or a flight path recorded in advance as input, and obtain the target path information of the current time point from the set path information. The target path information may include information of a position, an attitude, and angle of the flight body. The path calculator 320 may use the relative position information of the flight body 100 (flight body relative position information), the absolute position information of the base 500 (base absolute position information), and the target path information as inputs, and calculate flight body control information, that is needed for the flight body 100 to fly according to the set path, based on the position information of the target position and the current position of the flight body 100. The flight body control information may include control information related to control amounts such as pitch, roll, yaw, and height of the flight body. the transmitter 330 may include a communication interface for wired communication or wireless communication and may transmit the flight body control information to the flight body controller 110 through any one of wired communication methods or wireless communication methods. The flight control processor 300 may include a computer having a processor, a memory, and a communication circuit.

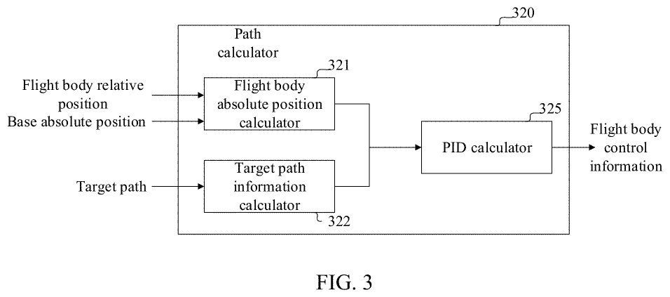

FIG. 3 is a schematic block diagram showing a functional configuration of a path calculator according to some embodiments of the present disclosure. The path calculator 320 includes a flight body absolute position calculator 321, a target path information calculator 322, and a PID calculator 325. The flight body absolute position calculator 321 may use the flight body relative position information and the base absolute position information as input to calculate the current absolute position of the flight body 100. The target path information calculator 322 may use the target path information as input and calculate the target position related to the target path for flying according to the set path. The PID calculator 325 may calculate the flight body control information (control amount information of the PID control), which may be used to perform flight control of the flight body 100, through the PID control technology according to the current absolute position (current position) of the flight body 100 and the target position.

The flight body controller 110 may use the flight body control information transmitted by the flight control processor 300 as input and control the propulsion unit, such as the rotor mechanism of the flight body 100, according to the flight body control information to control the flight operation of the flight body 100. When the flight body 100 includes the information processing device, the flight body controller 100 may be included in the information processing device.

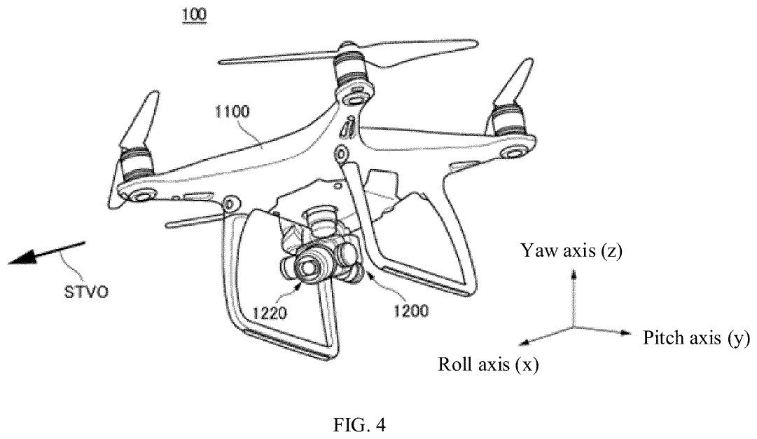

FIG. 4 is a schematic diagram showing an outer structure of a flight body according to some embodiments of the present disclosure. FIG. 4 shows a perspective diagram when the flight body 100 moves along a movement direction STV0.

As shown in FIG. 4, a roll axis is defined to be parallel to the ground surface and along the movement direction STV0 (x-axis). A pitch axis (y-axis) is set to be parallel to the ground surface and perpendicular to the roll axis. Further, a yaw axis (z-axis) is set to be perpendicular to the ground surface and perpendicular to the roll axis and the pitch axis.

The flight body 100 includes a UAV body 1100, a gimbal 1200, and an imaging unit 1220. The flight body 100 may be an example of a mobile body that includes the imaging unit 1220 and moves. The movement of the flight body 100 refers to flying and at least includes the flight of ascent, descent, left rotation, right rotation, left translation, and right translation.

The UAV body 1100 includes a plurality of rotors (propellers). The UAV body 1100 may control rotations of the plurality of rotors to cause the flight body 100 to fly. The UAV body 1100 may use, for example, four rotors to cause the flight body 100 to fly. A number of the rotors is not limited to four. In some embodiments, the flight body 100 may also be a fixed-wing aircraft without a rotor.

The imaging unit 1220 is an imaging camera that photographs an object (e.g., a building on the ground, an object for detection) within a desired imaging range. The imaging unit 1220 includes a function of the measurement unit 141 of performing photographing on the measurement target object 510 of the base 500 to obtain the measurement data.

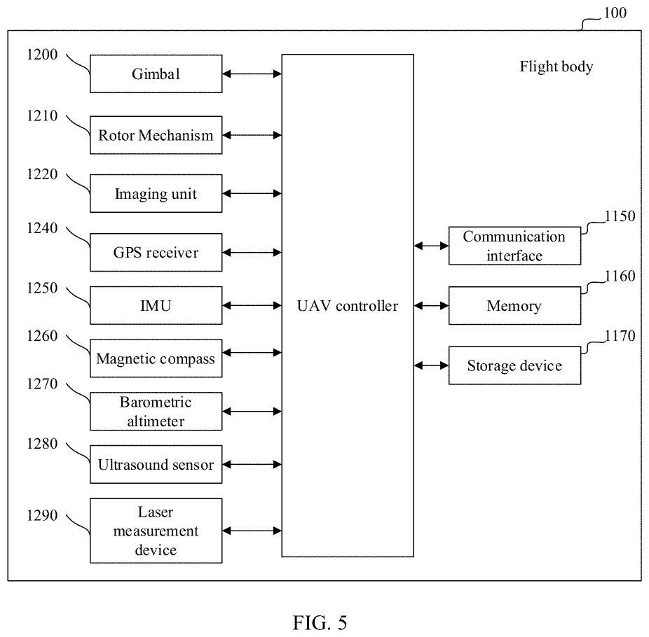

FIG. 5 is a schematic block diagram showing a hardware configuration of the flight body according to some embodiments of the present disclosure. The flight body 100 includes a UAV controller 1110, a communication interface 1150, a memory 1160, a storage device 1170, a gimbal 1200, a rotor mechanism 1210, an imaging unit 1220, a GPS receiver 1240, an IMU 1250, a magnetic compass 1260, a barometric altimeter 1270, an ultrasound sensor 1280, and a laser measurement device 1290.

The UAV controller 1110 may include a processor, for example, a central processing unit (CPU), a micro processing unit (MPU), or a digital signal processor (DSP). The UAV controller 1110 may execute signal processing, which is used to overall control operations of various units of the flight body 100, input and output processing of data with other units, data calculator processing, and data storage processing. The UAV controller 1110 may include the function of the flight body controller 1110.

The UAV controller 1110 may control the movement (i.e., flight) of the flight body 100 according to a program stored in the memory 1160. The UAV controller 1110 may control the flight when the flight body 100 flies automatically according to the flight body control information transmitted from the flight control processor 300. The UAV controller 1110 may control the flight of the flight body 100 according to a command received from a remote transmitter through the communication interface 1150.

The UAV controller 1110 may obtain the image (image data) of the object captured by the imaging unit 1220. The UAV controller 1110 may perform aerial photographing through the imaging unit 1220 and obtain an aerial image as the image. The UAV controller 1110 may include the function of the relative position measurement unit 140 of measuring the relative position of the flight body 100 relative to the base 500 according to the measurement data of the measurement target object 510 of the base 500 obtained by the measurement unit 141 of the imaging unit 1220.

The communication interface 1150 may communicate with the external information processing device and the terminal. The communication interface 1150 may perform the wireless communication through any wireless communication manner. The communication interface 1150 may perform the wired communication through any wired communication manner. The communication interface 1150 may transmit the image and additional information (metadata) related to the mage to the information processing device. The communication interface 1150 may obtain the flight body control information from the external information processing device.

The memory 1160 may store a program that is needed by the UAV controller 1110 for controlling the gimbal 1200, the rotor mechanism 1210, the imaging unit 1220, the GPS receiver 1240, the IMU 1250, the magnetic compass 1260, the barometric altimeter 1270, the ultrasound sensor 1280, and the laser measurement device 1290. The memory 1160 may be a computer-readable storage medium including at least one of a static random access memory (SRAM), a dynamic random access memory (DRAM), an erasable programmable read-only memory (EPROM), an electrically erasable programmable read-only memory (EEPROM), or a universal serial bus (USB) storage device. The memory 1160 may be arranged inside the UAV body. The memory 1160 may be detached from the flight body 100. The memory 1160 may record the image captured by the imaging unit 1220. The memory 1160 may operate as a job memory.

The storage device 1170 may save and store various data and information the storage device 1170 may include at least one of a hard disk drive (HDD), a solid-state drive (SSD), an SD card, a USB storage device, or another storage device. The storage device 1170 may be arranged inside the UAV body 1100. The storage device 1170 may be detached from the flight body 100. The storage device 1170 may record the image.

The gimbal 1200 can rotatably support the imaging unit 1220 using at least one axis as a center. The gimbal 1200 may cause the imaging unit 1220 to use at least one of the yaw axis, the pitch axis, or the roll axis as a rotation center to change the photographing direction of the imaging unit 1220. The imaging unit 1200 may include a function of the gimbal 1200 that is configured to adjust the direction of the imaging unit 1220 to cause the imaging unit 1220, which is used as an example of the measurement unit 141, to photograph the measurement target object 510 of the base 500.

The rotor mechanism 1210 may include a plurality of rotors and a plurality of motors that cause the plurality of rotors to rotate. The rotor mechanism 1210 may control the rotation by the UAV controller 1110 to cause the flight body 100 to fly.

The imaging unit 1220 may photograph the to-be-photographed object within the desired imaging range to generate data of the image. The image (image data) captured by the imaging unit 1220 may be stored in memory included in the imaging unit 1220, memory 1160, or storage device 1170. The imaging unit 1220 may include the TOF camera and RGB camera, which are used as the measurement unit 141.

The GPS receiver 1240 may receive a plurality of signals representing time and positions (coordinates) of GPS satellites transmitted from a plurality of navigation satellites (i.e., GPS satellites). The GPS receiver 1240 may calculate the position of the GPS receiver (i.e., the position of the flight body 100) according to the plurality of signals obtained. The GPS receiver 1240 may output the position information of the flight body 100 to the UAV controller 1110. In addition, the position information of the GPS receiver 1240 may be calculated by the UAV controller 1110 instead of the GPS receiver 1240. The information representing the time and the positions of the GPS satellites included in the plurality of signals received by the GPS receiver 1240 may be input into the UAV controller 1110.

The IMU 1250 may detect the attitude of the flight body 100 and output the detection result to the UAV controller 1110. The IMU 1250 may detect accelerations of three axis directions of front and back, left and right, and up and down and angular speeds of three axis directions of the pitch axis, the roll axis, and the yaw axis as the attitude of the flight body 100.

The magnetic compass 1260 may detect the orientation of the nose of the flight body 100 and output the detection result to the UAV controller 1110.

The barometric altimeter 1270 may detect a flight height of the flight body 100 and output the detection result to the UAV controller 1110.

The ultrasound sensor 1280 may emit ultrasound, detect the ultrasound reflected by the ground and object, and output the detection result to the UAV controller 1110. The detection result may represent, for example, a distance (i.e., height) from the flight body 100 to the ground. The detection result may also represent a distance, for example, from the flight body 100 to the object (e.g., to-be-photographed object).

The laser measurement device 1290 may irradiate laser to the object, receive the reflected light reflected by the object, and measure the distance between the flight body 100 and the object (e.g., to-be-photographed object) through the reflected light. The detection result may be input to the UAV controller 1110. A TOF method may be an example of a distance measurement method based on the laser. The laser measurement device 1290 may include a function of the measurement unit 141, which is configured to photograph the measurement target object 510 of the base 500 to obtain the measurement data. The laser measurement device 1290 may carry the gimbal 1200.

The UAV controller 1110 may obtain the position information, which represents the position of the flight body 100. The UAV controller 1110 may obtain a latitude, a longitude, and an altitude where the flight body 100 is from the GPS receiver 1240. The UAV controller 1110 may obtain latitude and longitude information representing the latitude and the longitude where the flight body is from the GPS receiver 1240 and obtain the altitude information representing the altitude where the flight body 100 is from the barometric altimeter 1270 as the position information. The UAV controller 1110 may obtain a distance between an irradiation point of the ultrasound generated by the ultrasound sensor 1280 and a reflection point of the ultrasound as the altitude information.

The UAV controller 1110 may obtain direction information representing the direction of the flight body 100 from the magnetic compass 1260. The direction information may be represented by, for example, an orientation corresponding to the direction of the nose of the flight body 100.

The UAV controller 1110 may be configured to photograph the to-be-photographed object in a horizontal direction, a direction with a preset angle, or a perpendicular direction via the imaging unit 1220 at photographing positions (including waypoints) in the set flight path. The direction with the preset angle may a direction with an angle of a preset value suitable for estimation of a 3D shape of the to-be-photographed object by the information processing device (UAV or platform).

The UAV controller 1110 may obtain the photographing range information representing photographing ranges of the imaging unit 1220. The UAV controller 1110 may obtain an image representing the imaging unit 1220 from the imaging unit 1220 as a parameter that is used to determine the photographing range. The UAV controller 1110 may obtain information representing the photographing direction of the imaging unit 1220 as a parameter that is used to determine the photographing range. The UAV controller 1110 may obtain information representing the attitude status of the imaging unit 1220 from the gimbal 1200 as, for example, information representing the photographing direction of the imaging unit 1220. The attitude information of the imaging unit 1220 may be presented by, for example, a rotation angle from a reference rotation angle of the pitch axis and yaw axis of the gimbal 1200. The UAV controller 1110 may obtain the information representing the direction of the flight body 100 as the information representing the photographing direction of the imaging unit 1220.

The UAV controller 1110 may control the gimbal 1200, the rotor mechanism 1210, and the imaging unit 1220. The UAV controller 1110 may control the photographing range of the imaging unit 1220 by changing the photographing direction or the view angle of the imaging unit 1220. The UAV controller 1110 may control the photographing range of the imaging unit 1220 supported by the gimbal 1200 by controlling the rotation mechanism of the gimbal 1200.

The UAV controller 1110 may control the flight of the flight body 100 by controlling the rotor mechanism 1210. That is, the UAV controller 1110 may control the position including the latitude, the longitude, and the altitude of the flight body 100 by controlling the rotor mechanism 1210. The UAV controller 1110 may control the photographing range of the imaging unit 1220 by controlling the flight of the flight body 100. The UAV controller 1110 may control the view angle of the imaging unit 1220 by controlling the zoom lens included in the imagining unit 1220. The UAV controller 1110 may control the view angle of the imaging unit 1220 through a digital zoom by using a digital zoom function of the imaging unit 1220.

The UAV controller 1110 may obtain date and time information representing the current date and time. The UAV controller 1110 may obtain the date and time information representing the current date and time from the GPS receiver 1240. The UAV controller 1110 may obtain the date and time information representing the current date and time from a timer (not shown) carried by the flight body 100.

In some embodiments, an operation of the flight control system is described below when the flight body 100 flies automatically. Processes corresponding to embodiments of the flight body 100, the base 500, and the flight control processor 300 shown in FIG. 1 are described below.

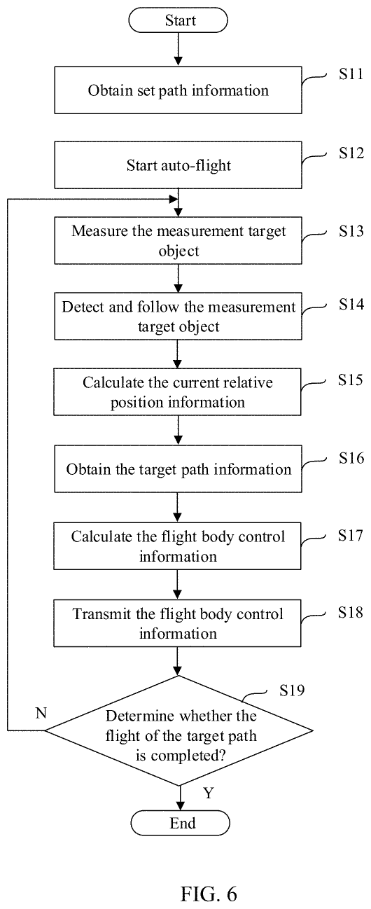

FIG. 6 is a schematic flowchart of a flight control operation according to some embodiments of the present disclosure. The flight control processor 300 may obtain the flight path preset by the user, the flight path calculated according to the parameter set by the user, or the set path information of the pre-recorded flight path (S11). The set path information may be input from, for example, an external terminal, an information processing device, or a memory. The flight control processor 300 may transmit the flight body control information generated according to the set path information to the flight body controller 110. The flight body controller 110 may control the flight operation of the flight body 100 according to the flight body control information to cause the flight body 100 to start auto-flight along the set path (S12).

The measurement unit 141 of the flight body 100 may measure the measurement target object 510 of the base 500 in real time to execute the measurement operation of the measurement target object (S13). The object detection unit 142 may detect and follow the measurement target object 510 according to the measurement data of the object and output the distance and angle information of the measurement target object 510 (S14). The relative position calculator 143 may calculate the current relative position information of the flight body 100 relative to the measurement target object 510 according to the distance and angle information of the measurement target object 510 (S15).

The target path acquisition unit 310 of the flight control processor 300 may obtain the target path information of the current time point from the set path information that has been input (S16). The path calculator 320 may calculate the flight body control information that is used to cause the flight body 100 to fly according to the set path from a comparison result of position information of the target position and the current position of the flight body 100 based on the relative position information of the flight body 100, the absolute position information of the base 500, and the target path information (S17). The transmitter 330 may transmit the obtained flight body control information to the flight body controller 110 (S18).

The flight body controller 110 may control the flight operation of the flight body 100 according to the flight body control information transmitted by the flight control processor 300 in real time to cause the flight body 100 to continue with the auto-flight along the set path. The flight body controller 110 may determine whether the flight according to the target path of the set path is completed (S19). When the target path is not completed (S19: No), operations related to the auto-flight control may be repeated. That is, the flight body 100 and the flight control processor 300 may repeatedly execute from operations from the measurement operation of the object at S13 the transmission operation of the flight body control information at S18. When the flight along the target path is completed (S19: Yes), processes related to the operation of controlling the auto-flight may be ended.

In some embodiments, for example, even if the position information of the flight body based on the GPS cannot be obtained sufficiently, the relative position information between the base and the flight body and the absolute position information of the base may be obtained to obtain the current position information of the flight body. In addition, controlling the auto-flight of the flight body along the target path may be accurately and easily performed according to the current position information of the flight body and the target path. Therefore, even if the flight body is in an environment where the signal of the GPS satellite is difficult to receive, for example, when the flight body is caused to fly automatically to inspect a bridge, the current position information of the flight body may be accurately obtained, and controlling of the auto-flight along the target path may be performed.

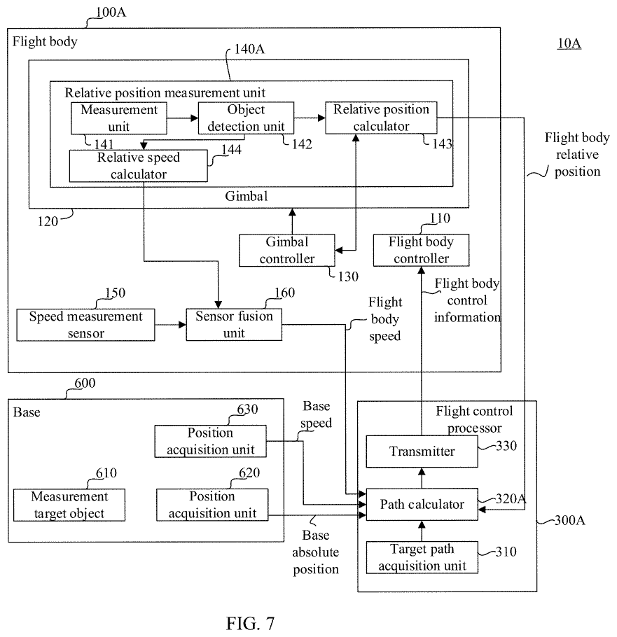

FIG. 7 is a schematic block diagram of another flight control system 10A according to some embodiments of the present disclosure. The flight control system 10A includes a flight body 100A, a flight control processor 300A, and a base 600. In some embodiments, the flight control system 10A further includes a speed measurement unit, and the base 600 is movable. The description of same elements as shown in FIG. 1 is omitted.

The flight body 100A includes a flight body controller 110, a gimbal 120, a gimbal controller 130, a speed measurement sensor 150, and a sensor fusion unit 160. The relative position measurement unit 140A carried by the gimbal 120 includes a measurement unit 141, an object detection unit 142, a relative position calculator 143, and a relative speed calculator 144.

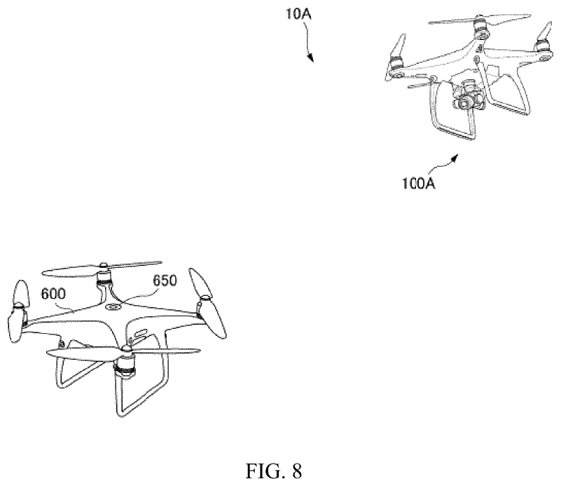

FIG. 8 is a schematic diagram of the flight control system 10A according to some embodiments of the present disclosure. FIG. 8 shows a situation that the base 600 is dynamically movable. The base 600 may be configured as a measurement target object for the flight body 100A to measure a relative position through photographing. The base 600 includes a sign 650. The sign 650 is formed and arranged at an outer surface of the base 600, e.g., an upper surface of the flight body. When the flight body 100A flies near the base 600, and the base 600 is moving or still, the base 600 may obtain its own absolute position information. The flight body 100A may measure the sign 650 of the base 600 through photographing, and measure the relative position between the flight body 100A and the base 600.

When devices fixed on the base 500 shown in FIG. 2 are difficult to use, the base 600 shown in FIG. 8, which is dynamically movable, may be implemented. The dynamically movable base may include, for example, a UAV, a ship, or a vehicle. For example, when the flight body 100A is controlled to fly automatically to perform side inspection on a structure such as a bridge, the signal from the GPS satellite may not be well received, and the position measurement may be difficult to be performed through the GPS. Even under this situation, the base 600 based on another flight body may be arranged near the flight body 100A as a movable base, such that the suitable position measurement and auto-flight control may be performed on the flight body 100A.

Referring again to FIG. 7, the base 600 includes a measurement target object 610 such as the sign 650, a position acquisition unit 620, which may be configured to obtain the position of the base 600, and a speed measurement sensor 630, which may be configured to measure the moving speed of the base 600.

The position acquisition unit 620 of the base 600, for example, may include a GPS measurement unit of a GPS sensor. The position acquisition unit 620 of the base 600 may be configured to measure the 3D position of the base 600 to obtain and output the absolute position information. The speed measurement sensor 630 may be configured to measure the moving speed of the base 600 to obtain and output base speed information representing the speed of the base 600.

The relative position calculator 143 of the flight body 100A may estimate and calculate the relative 3D position from the measurement target object 610 to the flight body 100A according to the information of the distance and the angle of the measurement target object 610 to obtain and output the relative position information of the flight body 100A. The relative speed calculator 144 may use the measurement unit 141 to obtain the image of the measurement target object 610 and record a timestamp of each frame of the image. The relative speed calculator 144 may estimate the relative speed of the flight body 100A relative to the measurement target object 610 according to the positions of the measurement target object at moments. The relative speed calculator 144 may use the relative speed as the relative speed information for output. The relative speed calculator 144 may calculate the relative speed information of the flight body 100A relative to the measurement target object 610 according to change information of the distance and the angle of the measurement target object 610. The speed measurement sensor 150 may include for example the IMU 1250. The speed measurement sensor 150 may obtain and output the moving speed information of the flight body 100A according to the acceleration information of the flight body 100A. The sensor fusion unit 160 may integrate detection information of a plurality of sensors through the sensor fusion technology to obtain more accurate measurement information. The sensor fusion unit 160 may select sensor detection results according to detection accuracies of the sensors that are different under different situations to output accurate measurement information. The sensor fusion unit 160 may integrate the relative speed information of the flight body 100A obtained by the relative speed calculator 144 and the moving speed information of the flight body 100A obtained by the speed measurement sensor 150, which is output as the flight body speed information representing the speed of the flight body 100A.

The flight control processor 300A may be an example of the information processing device disclosed by the present disclosure. The flight control processor 300A includes a target path acquisition unit 310, a path calculator unit 320A, and a transmitter 330. The path calculator 320A may use the relative position information of the flight body 100A (flight body relative position information), the speed information of the flight body 100A (flight body speed information), the absolute position information of the base 600 (base absolute position information), the speed information of the base 600 (base speed information), and the target path information as inputs, and calculate flight body control information, that is needed to cause the flight body 100 to fly according to the set path, based on the position information of the target position and the current position of the flight body 100A, and the speed information of the flight body 100A and the base 600.

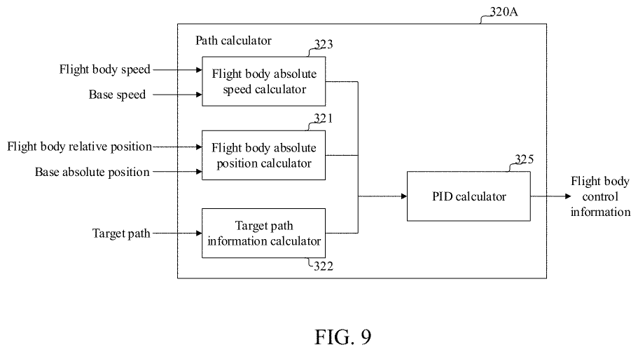

FIG. 9 is a schematic block diagram showing a functional configuration of the path calculator 320A according to some embodiments of the present disclosure. In some embodiments, the path calculator 320A includes a flight body absolute position calculator 321, a target path calculator 322, a flight body absolute speed calculator 323, and a PID calculator 325. The flight body absolute speed calculator 323 may use the flight body speed information and the base speed information as inputs to calculate the current absolute speed of the flight body 100A. The PID calculator 325 may calculate the flight body control information (control variable information of the PID control), which may be used to perform the flight control of the flight body 100A through the PID control technology according to the current absolute position (current position) and the absolute speed (current speed) of the flight body 100A. The path calculator 320A may calculate the flight body control information, which may be used to cause the flight body 100A to fly along to the set path according to the target position and the current position of the flight body 100A and a comparison result between the target speed and the current speed.

The flight body controller 110 may use the flight body control information transmitted by the flight control processor 300A as input and control the propulsion unit, such as the rotor mechanism of the flight body 100, according to the flight body control information to control the flight operation of the flight body 100. The flight body controller 110 may cause the flight body 100A to fly according to the target position and target through time based on the target path information and cause the flight body 100A to fly automatically along the set path. The flight body controller 110 may control the flight of the flight body 100A to cause the flight body 100A to perform the auto-flight along the set path to suit the target position and the target speed.

In some embodiments, by using the dynamically movable base, even in the environment where the base is not easy to be fixedly arranged, the base may be arranged in a visible range of the flight body, and the relative position of the base and the flight body and the absolute position information of the base may be easily obtained. For example, another flight body may be used as the base. The base may move according to the flight of the flight body. The position information of the flight body may be accurately obtained. Therefore, controlling the flight body to fly automatically along the target path may be performed accurately and easily.

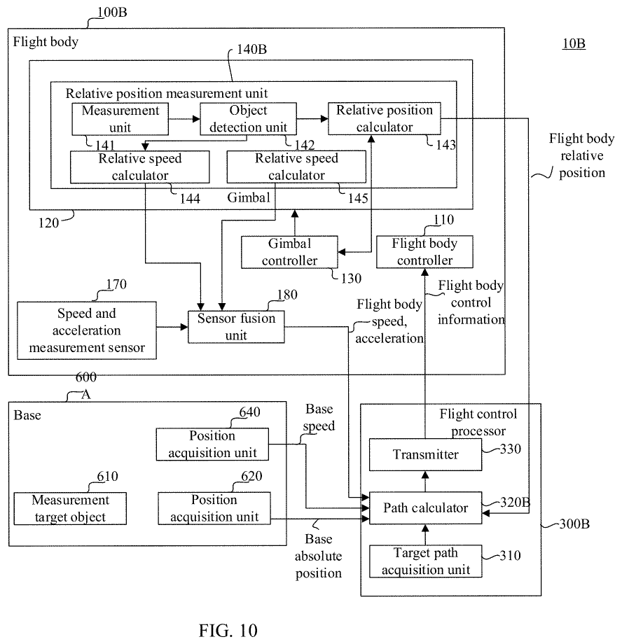

FIG. 10 is a schematic block diagram of another flight control system 10B according to some embodiments of the present disclosure. The flight control system 10B includes a flight body 100B, a flight control processor 300B, and a base 600A. In some embodiments, the flight control system 10B further includes an acceleration measurement unit compared to the flight control system 10A shown in FIG. 7, and the base 600A is movable. The description of the same elements as shown in FIG. 1 and FIG. 7 is omitted.

The flight body 100B includes a flight body controller 110, a gimbal 120, a gimbal controller 130, a speed and acceleration measurement sensor 170, and a sensor fusion unit 180. The relative position measurement unit 140B carried on the gimbal 120 includes a measurement unit 141, an object detection unit 142, a relative position calculator 143, a relative speed calculator 144, and a relative acceleration calculator 145.

The base 600A includes a measurement target object 610 such as the sign 650, a position acquisition unit 620, which may be configured to obtain the position of the base 600, and a speed and acceleration measurement sensor 640, which may be configured to measure the moving speed and the moving acceleration of the base 600A. The speed and acceleration measurement sensor 640 may measure the moving speed and the moving acceleration of the base 600A to obtain and output the base speed information representing the speed of the base 600A and the base acceleration information representing the acceleration.

The relative position calculator 143 of the flight body 100B may estimate and calculate the relative 3D position from the measurement target object 610 to the flight body 100B according to the information of the distance and the angle of the measurement target object 610 to obtain and output the relative position information of the flight body 100B. The relative speed calculator 144 may use the measurement unit 141 to obtain the image of the measurement target object 610 and estimate the relative speed of the flight body 100B relative to the measurement target object 610 from the positions of the measurement target object 610 at the moments. The relative speed calculator 144 may use the relative speed as the relative speed information for output. The relative speed calculator 144 may calculate the relative speed information of the flight body 100B relative to the measurement target object 610 according to change information of the distance and the angle of the measurement target object 610. The acceleration calculator 145 may be configured to calculate a change amount of the relative speed of the flight body 100B relative to the measurement target object 610 and use the change amount as the relative acceleration information for output. The speed and acceleration measurement sensor 170 may include for example the IMU 1250. The speed and acceleration measurement sensor 170 may obtain and output the moving acceleration and moving speed information of the flight body 100B. The sensor fusion unit 180 may integrate detection information of a plurality of sensors through the sensor fusion technology and output the flight body speed information and flight body acceleration information as more accurate measurement information. The sensor fusion unit 180 may integrate the relative speed information of the flight body 100B obtained by the relative speed calculator 144, the relative acceleration information of the flight body 100B obtained by the relative acceleration calculator 145, and the moving speed information and the moving acceleration speed of the flight body 100B obtained by the speed and acceleration measurement sensor 170, which are output as the flight body speed information representing the speed of the flight body 100A and the flight body acceleration information representing the acceleration.

The flight control processor 300B may be an example of the information processing device disclosed by the present disclosure. The flight control processor 300B includes a target path acquisition unit 310, a path calculator unit 320B, and a transmitter 330. The path calculator 320B may use the relative position information of the flight body 100B (flight body relative position information), the speed information of the flight body 100B (flight body speed information), the acceleration information of the flight body 100B (flight body acceleration information), the absolute position information of the base 600A (base absolute position information), the speed information of the base 600A (base speed information), the acceleration information of the base 600A (base acceleration information), and the target path information as inputs, and calculate flight body control information, that is needed to cause the flight body 100B to fly according to the set path, based on the position information of the target position and the current position of the flight body 100B, the speed information of the flight body 100B and the base 600A, and the acceleration information of the flight body 100B and the base 600A.

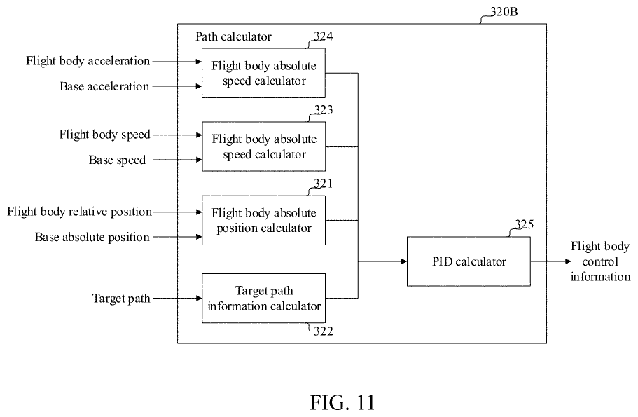

FIG. 11 is a schematic block diagram of a functional configuration of the path calculator 320B according to some embodiments of the present disclosure. In some embodiments, the path calculator 320B includes a flight body absolute position calculator 321, a target path calculator 322, a flight body absolute speed calculator 323, a flight body acceleration calculator 324, and a PID calculator 325. The flight body absolute speed calculator 323 may use the flight body speed information and the base speed information as inputs to calculate the current absolute speed of the flight body 100B. The flight body acceleration calculator 324 may use the flight body acceleration information and the base acceleration information as inputs to calculate the current absolute acceleration of the flight body 100B. The PID calculator 325 may calculate the flight body control information (control variable information of the PID control) that is used to perform the flight control of the flight body 100B through the PID control technology according to the current absolute position (current position), the absolute speed (current speed), the absolute acceleration (current acceleration), the target position, and the target speed of the flight body 100B. The path calculator 320B may calculate the flight body control information that is used to cause the flight body 100B to fly along to the set path according to the target position and the current position of the flight body 100A and a comparison result between the target speed and the current speed and the current acceleration.

The flight body controller 110 may use the flight body control information transmitted by the flight control processor 300B as input, and control the propulsion unit, such as the rotor mechanism of the flight body 100B, according to the flight body control information to control the flight operation of the flight body 100B. The flight body controller 110 may cause the flight body 100B to fly according to the target position and target through time based on the target path information and cause the flight body 100B to fly automatically along the set path. The flight body controller 110 may control the flight of the flight body 100B to cause the flight body 100B to perform the auto-flight along the set path to suit the target position and the target speed.

In some embodiments, in addition, to use the speed information of the flight body and the base, the acceleration information may be used to further improve the accuracy of the PID control. The acceleration may be measured for at least one of the flight body or the base. By calculating the flight control information that uses the acceleration information or correcting the speed information or position information that uses the acceleration information, the accuracy of the flight body control information may be further improved.

In some embodiments, as an example of the information processing device in the flight control system 10, the flight control processor 300 is included. The information processing device may generate the flight body control information that is used to perform control the flight operation on the flight body 100. The flight control system 10 includes the flight body 100, the base within the visible range of the flight body 100, which includes the measurement target object 510. When the base, which includes the measurement target object 510, is included in the visible range of the flight body 100, the flight control processor 300 may obtain the flight body relative position information indicating the relative position of the flight body 100 and the base 500 obtained by the flying body 100 measuring the measurement target object 510 in real time, and the base absolute position information indicating the absolute position of the base 500. The flight control processor 300 may use the set path information of the flight body 100 as input, obtain the target path information at the current time point from the set path information, and calculate the target position when the flight body 100 flies according to the set path based on the target path information. The flight control processor 300 may calculate the current absolute position of the flight body 100 according to the flight body relative position information and the base absolute position information. The flight control processor 300 may calculate the flight body control information that is used for the flight control of the flight body 100 according to the current absolute position and the target position of the flight body 100. The flight control processor 30 may transmit the flight body control information to the flight body controller 110 that controls the flight of the flight body 100.

Thus, even under a situation, for example, the position information of the flight body 100 based on the GPS may not be obtained sufficiently, the base relative position information and the flight body and the base absolute position information may be obtained to perform controlling the auto-flight along the target path accurately and easily.

In addition, in the flight body 100, the measurement target object 510 arranged at the base 500 may be measured by the measurement unit 141 and detected and followed by the object detection unit 142 to obtain the information of the distance and the angle of the measurement target object 510. The relative position calculator 143 may estimate the relative 3D position of the measurement target object 510 and the flight body 100 according to the information of the distance and the angle of the measurement target object 510 to calculate the flight body relative position information.

In addition, the measurement target object 510 may be a visible target. The flight body 100 includes the imaging unit that is used to photograph the visible target and used as the measurement unit 141 for measuring the measurement target object 510 and the gimbal 120 that causes the measurement unit 141 to face toward the measurement target object 510. The relative position calculator 143 may be configured to use the image of the measurement target object 510 captured by the measurement unit 141 to obtain the measurement information of the distance and the angle to the measurement target object 510 to calculate the flight body relative position information.

In addition, the measurement target object 510 may include a retro-reflector. The flight body 100 includes the laser scanner, which is configured to measure the measurement target object 510 and measure the distance and the angle relative to the retro-reflector of the measurement unit 141 and the gimbal 120, which causes the measurement unit 141 to face toward the measurement target object 510. The relative position calculator 143 may use the measurement information of the distance and the angle to the measurement target object 510 obtained by the measurement unit 141 to calculate the flight body relative position information.

In addition, when the base is a movable base 600, the flight control processor 300 may obtain the flight body relative position information indicating the relative position of the flight body 100 and the base 600, the flight body speed information indicating the speed of the flight body 100, the base absolute position information indicating the absolute position of the base 600, and the base speed information indicating the speed of the base 600. The flight control processor 300 may calculate the current absolute position of the flight body 100 according to the flight body relative position information and the base absolute position information, and calculate the absolute speed of the flight body 100 according to the flight body speed information and the base speed information. The flight control processor 300 may calculate the flight body control information that is used for the flight control of the flight body 100 according to the current absolute position, the absolute speed, and the target position of the flight body 100.

In addition, when the base is the movable base 600A, the flight control processor 300 may obtain the flight body relative position information indicating the relative position of the flight body 100 and the base 600A, the flight body speed information indicating the speed of the flight body 100, the flight body acceleration information indicating the acceleration of the flight body 100, the base absolute position information indicating the absolute position of the base 600A, the base speed information indicating the speed of the base 600A, and the base acceleration information indicating the acceleration of the base 600A. The flight control processor 300 may calculate the current absolute position of the flight body 100 according to the flight body relative position information and the base relative position information, calculate the absolute speed of the flight body 100 according to the flight body speed information and the base speed information, and calculate the absolute acceleration of the flight body 100 according to the flight body acceleration information and the base acceleration information. The flight control processor 300 may calculate the flight body control information that is used for the flight control of the flight body 100 according to the current absolute position, the absolute speed, the absolute acceleration, and the target position of the flight body 100.

In addition, the flight control system 10 for controlling the flight operation of the flight body 100 includes the flight body 100, the base 500, which is within the visible range of the flight body 100 and includes the measurement target object 510, and the information processing device, which is configured to generate the flight body control information that is used to control the flight operation of the flight body 100. The information processing device includes the flight control processor 300. The flight body 100 may measure the measurement target object 510, which is arranged at the base 500, in real time and calculate the flight body relative position information indicating the relative position to the base 500. The base 500 may obtain the base absolute position information indicating the absolute position f the base 500. The flight control processor 300 may use the set path information set in the flight body 100 as input, obtain the target path information of the current time point from the set path information, and calculate the target position according to the target path information when the flight body 100 flies along the set path. The flight control processor 300 may obtain the flight body relative position information and the base absolute position information, and calculate the current absolute position of the flight body 100 according to the flight body relative position information and the base absolute position information. The flight control processor 300 may calculate the flight body control information that is used for the flight control of the flight body 100 according to the current absolute position and the target position of the flight body 100 and transmit the flight body control information to the flight body controller 110 for controlling the flight body 100.

In addition, in some embodiments, examples of the information processing device for performing the flight control method included in any one of the flight control processors 300, 300A, and 300B arranged in the terminal such as the PC, inside the flight body, or in the base are described. The information processing device may be also included in another platform and be configured to perform the processes of the flight control method.

The present disclosure is described above with reference to embodiments, but the technical scope of the present disclosure is not limited to the scope described in the above embodiments. For those of ordinary skill in the art, various changes or improvements can be made to the above-described embodiments. It is apparent from the claims that such changes or improvements are within the technical scope of the invention.

Execution order of various processing such as operations, sequences, processes, and stages in the devices, systems, programs, and methods shown in the claims, the specifications, and the drawings, can be any order, unless otherwise specifically indicated by “before,” “in advance,” etc., and as long as an output of previous processing is not used in subsequent processing. Operation procedures in the claims, the specifications, and the drawings are described using “first,” “next,” etc., for convenience. However, it does not mean that the operation procedures must be implemented in this order.

What is claimed is:

1. An information processing device comprising:
a processor; and
a storage device storing a program that, when executed by the processor, causes the processor to:
obtain flight body relative position information and base absolute position information, the flight body relative position information indicating a relative position of a flight body relative to a base, the relative position being obtained by performing real time measurement on a measurement target object at the base, and the base absolute position information indicating an absolute position of the base;
receive set path information set in the flight body;
obtain target path information for a current time point from the set path information;
calculate, based on the target path information, a target position of the flight body for causing the flight body to fly along a set path;
calculate a current absolute position of the flight body according to the flight body relative position information and the base absolute position information;
calculate flight body control information according to the current absolute position of the flight body and the target position; and
control the flight body to fly according to the flight body control information.

2. The device of claim 1, wherein the program further causes the processor to:
perform measurement on the measurement target object;
perform detection and following on the measurement target object to obtain distance and angle information of the measurement target object; and
estimate, according to the distance and angle information of the measurement target object, a relative 3-dimensional position of the flight body relative to the measurement target object as the flight body relative position information.

3. The device of claim 1, wherein:
the measurement target object includes a visible target; and
the program further causes the processor to calculate the flight body relative position information based on an image of the measurement target object obtained through an imaging device of the flight body.

4. The device of claim 1, wherein:
the measurement target object includes a retro-reflector; and
the program further causes the processor to calculate the flight body relative position information based on distance and angle measurement information of the measurement target object obtained through a laser scanner of the flight body.

5. The device of claim 1, wherein:
the base includes a movable base; and
the program further causes the processor to:
obtain the flight body speed information indicating a speed of the flight body and base speed information indicating a speed of the base;
calculate an absolute speed of the flight body according to the flight speed information and the base speed information; and
calculate the flight body control information according to the current absolute position of the flight body, the absolute speed of the flight body, and the target position.

6. The device of claim 1, wherein:
the base is a movable base; and
the program further causes the processor to:
obtain flight body speed information indicating a speed of the flight body, flight body acceleration information indicating an acceleration of the flight body, base speed information indicating a speed of the base, and base acceleration information indicating an acceleration of the base;
calculate an absolute speed of the flight body according to the flight body speed information and the base speed information;
calculate an absolute acceleration of the flight body according to the flight body acceleration information and the base acceleration information; and
calculate the flight body control information according to the current absolute position of the flight body, the absolute speed of the flight body, the absolute acceleration of the flight body, and the target position.

7. A flight control method comprising:
obtaining flight body relative position information and base absolute position information, the flight body relative position information indicating a relative position of a flight body and a base, the relative position being obtained by performing real time measurement on a measurement target object at the base, and the base absolute position information indicating an absolute position of the base;
receiving set path information set in the flight body;
obtaining target path information at a current time point from the set path information;
calculating, cased on the target path information, a target position of the flight body for causing the flight body to fly along a set path;
calculating a current absolute position of the flight body according to the flight body relative position information and the base absolute position information;
calculating flight body control information according to the current absolute position of the flight body and the target position; and
controlling the flight body to fly according to the flight body control information.

8. The method of claim 7, wherein obtaining the flight body relative position information including:
performing measurement on the measurement target object;
performing detection and following on the measurement target object to obtain distance and angle information of the measurement target object; and
estimating, according to the distance and angle information of the measurement target object, a relative 3-dimensional position of the flight body relative to the measurement target object as the flight body relative position information.

9. The method of claim 7, wherein:
the measurement target object includes a visible target; and
obtaining the flight body relative position information includes:
calculating the flight body relative position information based on an image of the measurement target object obtained through an imaging device of the flight body.

10. The method of claim 7, wherein:
the measurement target object includes a retro-reflector; and
obtaining the flight body relative position information includes:
calculate the flight body relative position information based on distance and angle measurement information of the measurement target object obtained through a laser scanner of the flight body.

11. The method of claim 7,
wherein the base includes a movable base;
the method further comprising:
obtaining the flight body speed information indicating a speed of the flight body, and base speed information indicating a speed of the base;
calculating an absolute speed of the flight body according to the flight speed information and the base speed information; and
calculating the flight body control information according to the current absolute position of the flight body, the absolute speed of the flight body, and the target position.

12. The method of claim 7,
wherein the base is a movable base;
the method further comprising:
obtaining flight body speed information indicating a speed of the flight body, flight body acceleration information indicating an acceleration of the flight body, base speed information indicating a speed of the base, and base acceleration information indicating an acceleration of the base;
calculating an absolute speed of the flight body according to the flight body speed information and the base speed information;
calculating an absolute acceleration of the flight body according to the flight body acceleration information and the base acceleration information; and
calculating the flight body control information according to the current absolute position of the flight body, the absolute speed of the flight body, the absolute acceleration of the flight body, and the target position.

13. A flight control system comprising:
a flight body;
a base including a measurement target object;
a processor; and
a storage device storing a program that, when executed by the processor, causes the processor to:
obtain flight body relative position information and base absolute position information, the flight body relative position information indicating a relative position of the flight body relative to the base, the relative position being obtained by performing real time measurement on the measurement target object, and the base absolute position information indicating an absolute position of the base;
receive set path information set in the flight body;
obtain target path information for a current time point from the set path information;
calculate, based on the target path information, a target position of the flight body for causing the flight body to fly along a set path;
calculate a current absolute position of the flight body according to the flight body relative position information and the base absolute position information;
calculate flight body control information according to the current absolute position of the flight body and the target position; and
control the flight body to fly according to the flight body control information.

14. The system of claim 13, wherein the program further causes the processor to:
perform measurement on the measurement target object;
perform detection and following on the measurement target object to obtain distance and angle information of the measurement target object; and
estimate according to the distance and angle information of the measurement target object, a relative 3-dimensional position of the flight body relative to the measurement target object as the flight body relative position information.

15. The system of claim 13, wherein:
the measurement target object includes a visible target; and
the program further causes the processor to calculate the flight body relative position information based on an image of the measurement target object obtained through an imaging device of the flight body.

16. The system of claim 13, wherein:
the measurement target object includes a retro-reflector; and
the program further causes the processor to calculate the flight body relative position information based on distance and angle measurement information of the measurement target object obtained through a laser scanner of the flight body.

17. The system of claim 13, wherein:
the base includes a movable base; and
the program further causes the processor to:
obtain the flight body speed information indicating a speed of the flight body and base speed information indicating a speed of the base;
calculate an absolute speed of the flight body according to the flight speed information and the base speed information; and
calculate the flight body control information according to the current absolute position of the flight body, the absolute speed of the flight body, and the target position.

18. The system of claim 13, wherein:
the base is a movable base; and
the program further causes the processor to:
obtain flight body speed information indicating a speed of the flight body, flight body acceleration information indicating an acceleration of the flight body, base speed information indicating a speed of the base, and base acceleration information indicating an acceleration of the base;
calculate an absolute speed of the flight body according to the flight body speed information and the base speed information;
calculate an absolute acceleration of the flight body according to the flight body acceleration information and the base acceleration information; and
calculate the flight body control information according to the current absolute position of the flight body, the absolute speed of the flight body, the absolute acceleration of the flight body, and the target position.
